(19) United States
(12) Patent Application Publication
(10) Pub. No.: US 2010/0146105 A1
(43) Pub. Date: Jun. 10, 2010

(54) BROADBAND SERVICE DELIVERY

(75) Inventor: Magnus Lundstrom, Johanneshov (SE)

Correspondence Address: FAEGRE & BENSON LLP;PATENT DOCKETING - INTELLECTUAL PROPERTY, 2200 WELLS FARGO CENTER, 90 SOUTH SEVENTH STREET, MINNEAPOLIS, MN, 55402-3901, US

(73) Assignee: PACKETFRONT SYSTEMS AB, KRISTA (SE)

(21) Appl. No.: 12/532,487

(22) PCT Filed: Mar. 20, 2008
(86) PCT No.: PCT/EP08/53369

§ 371 Date: Feb. 16, 2010

(30) Foreign Application Priority Data
Mar. 22, 2007 (EP) 07104714.6

(51) Int. Cl. G06F 15/173; G06F 15/16

(52) U.S. Cl. 709/224; 709/228

(57) ABSTRACT

Service is delivered from a service provider to a customer in a network system having a plurality of service providers and a network control and provisioning system through which connection of the customer and service provider is controlled. The service provider is connected to the control and provisioning system via a service manager application which contains predetermined values of conditional data parameters for services to be provided to the customer and the customer's connection to the network is interrogated by the service manager to determine the current values of conditional data parameters. The current values are compared with the predetermined values to determine whether or not conditions for provision of the requested services are met. The results of the comparison are communicated to the service provider.

### TECHNICAL FIELD

This invention relates to a method of delivering a service over a broadband network between a service provider and a customer. In particular, the invention relates to such methods where multiple service providers have access to customers over a network that is separately managed and operated.

### BACKGROUND ART

In many prior art broadband networks, the network operator and the service provider to the customer are one and the same. While the network operator/service provider may source services from other service providers, the customer has just one contact point. However, in many cases, it is now common that customers may obtain services from service providers that are different from the network operator. In an open network environment, the objective is to allow the customer to contact one of a number of service providers to obtain a given service which is then provided via the network operated by the network operator.

FIG. 1 shows a generic description of a broadband network for providing telephone, internet and TV/video services to subscribers in a number of locations. A series of service providers provide the various services (SP1, SP2, SP3) to the network 10 via conventional access points 12. The network 10 provides connects these to subscribers via routers 14 located close to the subscribers. These can include business locations that can include routers in commercial property 16, and domestic subscribers with routers located in a central office 18 for a neighbourhood of separate dwellings (houses 17), or in a single building 19 such as an apartment building.

Operation of the network is controlled by a control and provisioning system 20 that configures the various elements of the network to operate in the desired manner.

The nature of the network service provided to users means that when a customer requests a particular service from a service provider, it is necessary for the service provider to check that the correct network connection is available for the delivery of that service to take place. For example, it is likely that only one TV/Video service will be allowed per customer. Therefore, before initiating a TV/Video service, it is necessary for the service provider to know whether or not there is already a TV/Video service provided to that user. In the past, this has been achieved by providing full details of all services provided to the requesting customer to the service provider who can then determine whether or not the requested service can be provided. Where the service provider and network operator are the same, this is not a particular problem. However, where there is the possibility of several competing service providers being able to provide services to a customer, it is undesirable to allow any one service provider to see all of the information for a given customer since this may include confidential information between the customer and an existing service provider (e.g. the identity of existing service providers, or the level of service currently provided).

The problem addressed by the invention is therefore to enable only the information about a customer essential to the provision of a new service to be provided to a service provider when a new service is requested. The invention achieves this objective by means of a service manager application forming part of a network provisioning and control system to extract the appropriate data.

### DISCLOSURE OF THE INVENTION

This invention provides a method of delivering a service from a service provider to a customer in a network system comprising a plurality of service providers and a network control and provisioning system through which connection of the customer and service provider is controlled, the method comprising:

connecting the service provider to the control and provisioning system via a service manager application which contains predetermined values of conditional data parameters for services to be provided to the customer;
on receipt of a request from a service provide to provide a service to the customer, interrogating the customer's connection to the network by means of the service manager to determine the current values of the conditional data parameters and comparing the current values with the predetermined values to determine whether or not conditions for provision of the requested service are met; and
communicating the result of the comparison to the service provider to either confirm the requested service or to indicate which of the conditional data parameters does not meet the conditions.

The conditional data parameters preferably include the presence or absence of another service or collection of services, the bandwidth of the connection, the size of any unassigned bandwidth, the total number of services, and/or the presence or absence of customer equipment.

It is particularly preferred that only the values and identities of the conditional parameters not meeting the conditions is communicated to the service provider, and that no data relating to any other service providers is communicated from the service manager to the service provider.

By using the service manager to communicate the information to the service provider, the confidentiality of services provided to the customer by other service providers can be maintained.

### BRIEF DESCRIPTION OF THE DRAWINGS

FIG. 1 shows a generic broadband network;

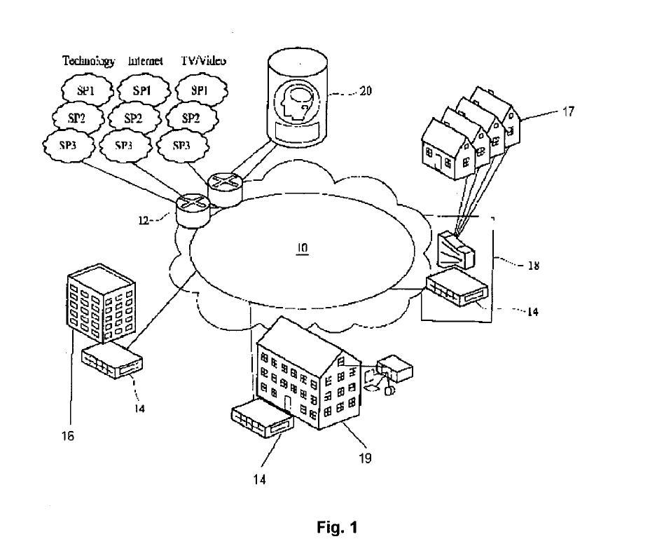

FIG. 2 shows a functional diagram of a network; and

FIG. 3 shows the basic components of a control and provisioning system.

### MODE(S) FOR CARRYING OUT THE INVENTION

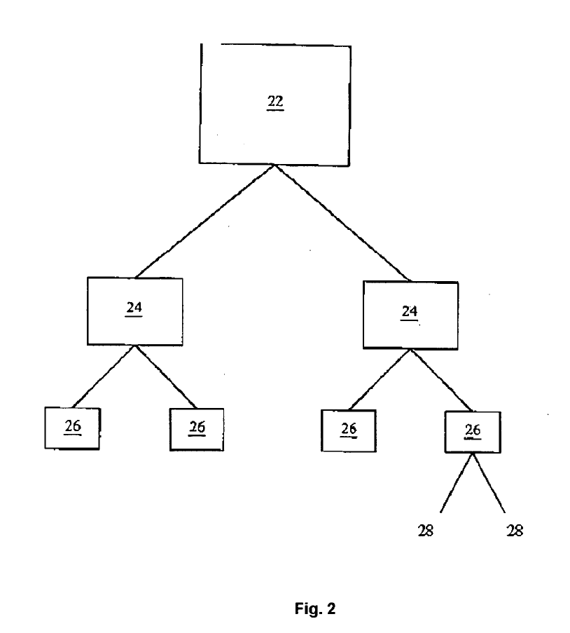

The present invention is implemented in the control and provisioning system 20. For the function of the control and provisioning system 20, the network can be considered in an abstract way as comprising a core 22 having one or more cells 24, each cell having one or more network elements 26 as is shown in FIG. 2. Subscribers 28 connect to the network elements 26. This structure is not to be confused with the physical elements making up the network. The functional blocks 22, 24, 26 may be wholly or partly resident in the same or different physical elements, depending on the exact size and makeup of the network in question, although typically, each network element 26 will comprise a router.

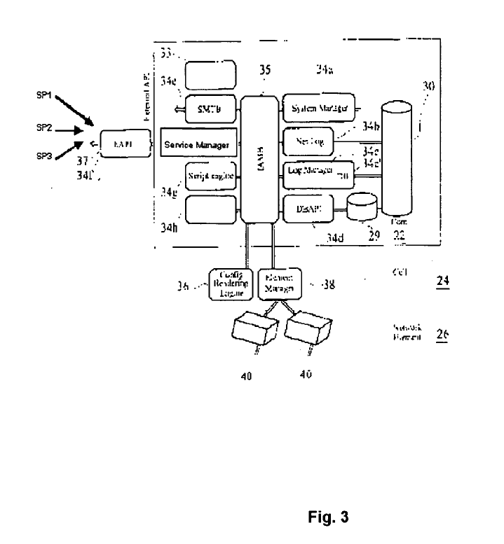

FIG. 3 shows a system suitable for implementing the invention. This system is described in more detail in European patent application 05077477.7. The core 22 comprises a file system 30, a database 32, a core module element manager 33, and a set of modules 34a-h that provide the core services for the network. The file system 30, database 32 and modules 33, 34 are all located on a central server, although it is possible that the various components could be distributed over more than one server. The core modules 34 interact with each other, the cells 24 and network elements 26. The core 22 also interacts with external applications such as service provider systems via an external API 37. The core modules 34 comprise a system manager module 34a, a net log module 34b, a log manager module 34c, a database application interface 34d, a subscriber management tool bridge 34e, an external application interface 34f, a script engine 34g, and a configuration job manager 34h. The various core modules 34 communicate with each other via an inter-application message bus 35. Each cell 24 comprises modules that handle that part of the network topology in that cell. The cell 24 can be located on the same server as the core 22, but in the case of a large network, the cell 24 may be separated from the core server and deployed in the network. Each cell includes a configuration rendering engine module 36 and an element manager module 38. Each network element 26 typically comprises a programmable router 40. The subscribers 28 connect equipment such as pcs, TVs and phones to an assigned port on the router 40

The invention resides in a service manager application 42 which sits between the external application interface 34f, via which the service providers SP1, SP2, SP3 interact with the control and provisioning system 20, and the remainder of the system, including the subscribers 28.

In use, a customer will contact the service provider to request a particular service. This contact can be direct via phone, email or the like. On receipt of the request, the service provider sends a request to the control and provisioning system 20 via the external application interface 34f to provide the requested service to the port in question. The service manager application 42 includes a database of the necessary conditions for any predetermined service to be provided to a port. These conditions can include various parameters, including:

Denial of service if an identical service is already provided to that customer from another service provider (e.g. there is already a TV service provided so no further TV service can be allowed until the first service is cancelled).
Bandwidth of service provided (e.g. minimum total bandwidth requirement of >10 Mbits, minimum unassigned bandwidth of >2 Mbits, etc.).
Permission only if another service is already provided to that user (e.g. a video on demand service may only be provided if a TV service already exists).
Maximum number of services provided to a given user.
Service only allowed as part of a bundle (e.g. email may only be provided with general Internet access).

These parameters can be stored in a lookup table. The service manager application 42 interrogates the system using the existing communication resource in the control and provisioning system 20 to determine the current values of the various parameters determined for that service. The interrogation can be at the level of the customer's equipment, the router 40 or any point in the network service relating to that customer. By comparing the current values of the parameters with the required value stored in the database, the service manager application 42 can determine whether or not the service can be provided. In the event that the necessary parameters are present for the requested service, the service manager application 42 confirms to the requesting service provider and enables the control and provisioning system 20 to initiate the new service to the customer.

In the event that one or more of the necessary conditions is not met, the service manager application returns a message to the service provider indicating which required condition is not met and why. For example, if an identical service is already provided, this is communicated to the service provider but not the identity of the existing service provider. Thus the confidential relationship between the existing service provider and the customer is not breached. The customer is then advised of the problem and can take any action necessary to bring everything into line (e.g. upgrade bandwidth, remove existing service, etc.).

If the requested service is one for which there is no entry in the database, the service manager application 42 initiates a communication to the service provider to contact the network operator and establish the values for the necessary conditions to provide that service. These can then be stored in the database and used for the next request of the service. The same approach can be taken where the conditions for a service change, for example decoupling of previously linked services.

Various changes can be made while staying within the scope of the invention. For example, the values and nature of the predetermined parameters can be selected according to the requirements of the network system.

1. A method of delivering a service from a service provider to a customer in a network system comprising a plurality of service providers and a network control and provisioning system through which connection of the customer and service provider is controlled, the method comprising:
connecting the service provider to the control and provisioning system via a service manager application which contains predetermined values of conditional data parameters for services to be provided to the customer;
on receipt of a request from a service provide to provide a service to the customer, interrogating the customer's connection to the network via the service manager to determine current values of the conditional data parameters and comparing the current values with the predetermined values to determine whether or not conditions for provision of the requested service are met; and
communicating the result of the comparison to the service provider to either confirm the requested service or to indicate which of the conditional data parameters does not meet the conditions.

2. A method as claimed in claim 1, wherein the conditional data parameters include a parameter selected from the group consisting of the presence or absence of another service or collection of services, the bandwidth of the connection, the size of any unassigned bandwidth, the total number of services, and the presence or absence of customer equipment.

3. A method as claimed in claim 1, wherein only the values and identities of the conditional parameters not meeting the conditions is communicated to the service provider.

4. A method as claimed in claim 1, wherein no data relating to any other service providers is communicated from the service manager to the service provider.

5. A method as claimed in claim 2, wherein only the values and identities of the conditional parameters not meeting the conditions is communicated to the service provider.

6. A method as claimed in claim 2, wherein no data relating to any other service providers is communicated from the service manager to the service provider.

7. A method as claimed in claim 3, wherein no data relating to any other service providers is communicated from the service manager to the service provider.

8. A method of delivering a service from a service provider to a customer in a network system comprising a plurality of service providers and a network control and provisioning system through which connection of the customer and service provider is controlled, the method comprising:
connecting the service provider to the control and provisioning system via a service manager application which contains predetermined values of conditional data parameters for services to be provided to the customer;
on receipt of a request from a service provide to provide a service to the customer, interrogating the customer's connection to the network via the service manager to determine current values of the conditional data parameters and comparing the current values with the predetermined values to determine whether or not conditions for provision of the requested service are met; and
communicating the result of the comparison to the service provider only information germane to the service provider.

9. A method as claimed in claim 8, wherein the conditional data parameters include one or more of the presence or absence of another service or collection of services, the bandwidth of the connection, the size of any unassigned bandwidth, the total number of services, or the presence or absence of customer equipment.

10. A method as claimed in claim 8, wherein only the values and identities of the conditional parameters not meeting the conditions is communicated to the service provider.

11. A method as claimed in claim 8, wherein no data relating to any other service providers is communicated from the service manager to the service provider.

12. A method as claimed in claim 9, wherein only the values and identities of the conditional parameters not meeting the conditions is communicated to the service provider.
